(19) United States
(12) Patent Application Publication
(10) Pub. No.: US 2022/0169572 A1
(43) Pub. Date: Jun. 2, 2022

(54) INVESTMENT POWDER

(71) Applicant: GOODWIN PLC, Stoke-On-Trent, Staffordshire (GB)

(72) Inventors: Simon Robert GOODWIN, Stoke-On-Trent, Staffordshire (GB); Michael Gerard PALIN, Stoke-On-Trent, Staffordshire (GB)

(21) Appl. No.: 17/599,288

(22) PCT Filed: Mar. 26, 2020
(86) PCT No.: PCT/GB2020/050808

§ 371 Date: Sep. 28, 2021

(30) Foreign Application Priority Data
Mar. 29, 2019 (GB) 1904495.7
May 17, 2019 (GB) 1906989.7

(51) Int. Cl. C04B 35/447; B22D 15/00; B22C 1/00

(52) U.S. Cl. CPC C04B 35/447; B22D 15/00; C04B 2235/3418; C04B 2235/3206; B22C 1/00

(57) ABSTRACT

An investment powder which is safer than conventional powders comprising tricalcium phosphate, and being substantially or entirely free of free silica in the respiratory portion yet providing an overall expansion at 750° C. of 1% or higher sufficient to prevent mould cracking during casting. A method of making a casting comprising forming a slurry by mixing a gypsum bonded investment powder with water, pouring the slurry into a stainless steel flask around a low melting point material model, allowing the slurry to set to define a mould, heating the mould to burn out the model and casting material into the mould wherein the stainless steel flask consists of a 400 series martensitic stainless steel.

This invention relates to the powders used in the production of moulds in the block mould precision casting process.

In the block mould casting process a model is made of the final desired shape from a low melting point organic material such as wax or plastic. The model is then placed in a container which is typically a cylindrical steel container and generally referred to as a flask. A powder, sometimes referred to as an investment powder, is mixed with water to form a slurry which is introduced into the container so that the space around the model is filled. Once the slurry has set, the model is removed by melting or burning using steam or placing in a furnace. This leaves a cavity in the mould material of the same shape as the model. The container is then further heated to burn out any carbon residue and to bring the mould to the correct temperature for casting. The metal is cast by pouring liquid metal into the mould. This may be done, for example, under the influence of gravity or centrifugal force. Once the metal has solidified the mould may be broken and the metal cleaned.

Many types of metal products are made using block mould casting process because of the high dimensional accuracy and accurate reproduction of surface detail which can be achieved at relatively low cost. Examples of products manufactured by investment casting include jewellery, sculpture, dental products and larger castings for industrial applications. Metals which may be investment cast include gold, silver, platinum group metals, aluminium alloys, brass and bronze alloys. Glass and other ceramics may also be cast by using the investment casting process.

A good investment powder should provide castings with a good surface finish that are free of cracks or flashing.

If the expansion of the powder when the flask is being heated up in the furnace does not match the expansion of the metal flask containing the solidified powder and wax tree (e.g. if the powder expands less than the flask) then the expansion of the wax tree and wax patterns will fracture the refractory mould as the wax expands before it becomes molten and drains out of the flask. Wax can expand up to 15% before melting. This fracturing of the mould is called wax flashing as when the mould is filled with metal under pressure from a vacuum or the centrifugal force the fracture will open up and metal flashing will occur on the surface of the casting.

If the solidified powder is not sufficiently porous then during the burnout cycle the remaining water has difficulty escaping which can result in spalling on the casting surface where the mould has been pushed into the wax pattern.

The solidified investment powder must be able to withstand the forces of the metal entering into the mould without fracturing and allowing the metal to spill out before the metal has solidified.

An investment powder conventionally consists of a refractory component, usually quartz, cristobalite or a mixture of both, and a binder. Typically the binder is gypsum (gypsum-bonded-investments or GBI) or where casting is at higher temperature ammonium magnesium phosphate (phosphate-bonded-investments or PBI). Conventionally GBI investment powder consists of approximately 25% plaster, 30%-40% quartz, 40% cristobalite and 1% additives. In most applications, these components may be ground to very fine powders giving the final casting an excellent surface finish.

Unfortunately quartz and cristobalite being silica polymorphs consist of free silica which requires careful handling and safety measures particularly when present in fine particles. Free silica has been shown to be responsible for respiratory diseases such as silicosis and other more severe lung diseases. It is an object of the present invention to provide an improved investment powder which comprises low levels of silica and which thus minimises or avoids the safety issues surrounding conventional investment powders.

According to the present invention there is provided an investment powder comprising tricalcium phosphate, and containing less than 3% preferably less than 1% and preferably less than 0.1% free silica in the respiratory fraction. In a preferred embodiment the investment powder further comprises plaster. Preferably the tricalcium phosphate is synthetic tricalcium phosphate. Tricalcium phosphate has the molecular formula Ca₃(PO₄)₂. Most preferably the tricalcium phosphate is anhydrous e.g. anhydrous Ca₃(PO₄)₂. Preferably the plaster is aridised beta plaster. Aridised plaster is described in more detail below. In a further preferred embodiment the investment powder additionally comprises magnesium oxide. The magnesium oxide is preferably dead burned magnesite. Magnesite is a mineral of formula MgCO₃.

The invention provides an investment powder which is safer than conventional powders. The investment powder may be entirely or substantially free of free silica yet may have a setting expansion of greater than 0.4%] and an overall expansion at 750° C. of 0.7% or higher, such as 1% or preferably 2% or more. The invention may then provide an investment powder which has a high enough setting and thermal expansion to prevent mould cracking during casting.

According to a further aspect of the present invention there is provided a method of making an investment casting mould from gypsum based investment powder by forming an investment casting slurry by mixing a gypsum bonded investment powder with water, pouring the slurry into a stainless steel flask around a low melting point material model, allowing the slurry to set to define a mould, and heating the mould to burn out the model wherein the stainless steel flask consists of a 400 series martensitic stainless steel, preferably 410 stainless steel. A metal casting may be formed by casting molten metal into the mould and allowing the metal to solidify. The gypsum based investment powder may be a conventional gypsum/quartz/cristobalite powder or an investment powder as described above.

According to another aspect of the present invention there is provided a method of making an investment casting slurry comprising mixing an investment powder as above with water. This method can provide an investment casting slurry which does not require more water to be added to make it flow than is required by conventional silica based investment powders. The method is safer than conventional methods because of the absence of free silica in small particle sizes. Further the method provides an investment casting slurry which has a high enough setting and thermal expansion to prevent mould cracking during casting.

Several criteria which should preferably be met by the casting produced can be heavily dependent upon the investment powder used. To produce an accurate mould it is important that the investment powder when mixed with an amount of water gives a slurry of sufficient fluidity to fill in all the gaps around the model. The mould should be completely filled by the molten metal. The model should be accurately reproduced. The surface of the cast metal should be an accurate reproduction of the details of the mould. The cast products should be consistent in size and weight and be defect free. Casting defects may typically include flashing or finning which may be attributed to mixing too much water with the investment powder. Too little water may give an investment slurry which has too high a viscosity resulting in bubbles forming on the casting surface. Water marking on the casting can also occur if the filler materials settle out of suspension or too much water is used.

If the mould material is too weak then the mould may crack during heating or casting and result in an unacceptable casting. In less severe cases, a weak mould material can result in flashing or finning of the casting and the casting will then require additional finishing work.

Presently quartz and cristobalite are used in investment powders because, in combination with the plaster, they can impart high strength to the mould. This is a result of the compressive forces generated by the expansion of the mould material during the setting and heating cycles. During setting the plaster can absorb water and expand. This so called setting expansion may ensure that the mould mixture expands against the container and so imparts strength to the mould through the compressive forces generated. The inclusion of quartz and cristobalite means that the setting expansion can be as high as 1% though the precise amount is very sensitive to the plaster/quartz/cristobalite ratio. During heating the plaster becomes anhydrous and shrinks. At the same time the metal container expands. This plaster shrinkage and container expansion should be compensated for by the expansion of the remaining components of the investment powder, otherwise the strength of the mould will decrease and there is a risk of damage to the mould resulting in flashing of the resultant metal product. During heating, quartz and cristobalite experience phase transformations at about 250° C. and 570° C. In each case the mineral transforms from alpha to beta phase which is accompanied by a large positive change in volume. This expansion can result in the compressive forces generated (and therefore the strength of the mould) remaining high throughout the temperature range experienced by the mould despite the possible decrease in volume of the plaster at the higher temperatures. This is why quartz and cristobalite have been used up till now. Some minerals undergo phase transformations and so expand but at a much higher temperature than quartz and cristobalite. The expansion of these minerals through phase transformation cannot be used to counteract the plaster shrinkage as the plaster binder used in the investment will decompose rapidly above 800° C.

The target criteria established for a replacement investment powder as a result of the above were that it should be substantially free of free silica yet have a setting expansion preferably of greater than 0.2% preferably greater than 0.5% such as 0.8% and more preferably 1% or more and an overall expansion at 750° C. preferably greater than 0.7% and more preferably greater than 1% such as 2% or more. The investment powder should preferably not require more water to be added to make it flow than is required by conventional silica based investments. Typically the amount of water added is less than 50% w/w; such as less than 40% w/w; e.g. less than 30% w/w; for example less than 20% w/w. Above all it should be capable of regularly producing satisfactory castings.

In summary there is need to achieve the following from a good investment casting powder:

1) Good surface finish;

2) Good porosity to enable fast burn out cycles;

3) Good fluidity so that fine detail of the wax can be replicated;

4) Good expansion as the temperature rises from 20 degrees centigrade to 700 degrees centigrade plus;

5) Fast solidification so that the total process cycle can be minimised;

6) Capable of withstanding 780° C. during the burnout cycle.

After considerable investigation it has been found that tricalcium phosphate can be used as a refractory component to provide the basis of a satisfactory gypsum bonded investment powder capable of fulfilling the above criteria. The tricalcium phosphate provides the heat expansion necessary for the investment powder to function during the various stages described above.

Calcium phosphate is a main combustion product of bones. Calcium phosphate may also be derived from mineral rock. The calcium phosphate in the investment powder of the invention is tricalcium phosphate. Tricalcium phosphate occurs naturally in mineral rock but synthetic tricalcium phosphate is preferred. Synthetic tricalcium phosphate may be formed by treating hydroxyapatite with phosphoric acid and slaked lime to produce an amorphous tricalcium phosphate which forms crystalline tricalcium phosphate on calcination. There are three forms of crystalline tricalcium phosphate; the rhombohedral β-form and two high temperature forms, monoclinic α- and hexagonal α′-. A skilled artisan will be able to select the most appropriate crystal form for use in the investment powder for any specific application.

The amount of tricalcium phosphate present in the investment powder determines the properties of the powder and can be varied in order to obtain the desired properties. Generally the investment powder comprises from about 25% to about 75% by weight tricalcium phosphate (e.g. from about 25% to about 75% Ca₃(PO₄)₂. Preferably the investment powder comprises more than 30% to about 70% by weight tricalcium phosphate. More preferably the investment powder comprises from about 35% to about 65% tricalcium phosphate, preferably synthetic tricalcium phosphate, e.g. from about 40% to about 60% such as from about 38% to about 53% tricalcium phosphate e.g. from about 39% to about 50% tricalcium phosphate, e.g about 48% tricalcium phosphate. Any suitable source of tricalcium phosphate can be used in the investment powder of the invention. Tricalcium phosphate (Ca₃(PO₄)₂) is commercially widely available. The tricalcium phosphate may be in the form of a hydrate or an anhydrous material. Preferably, the tricalcium phosphate has a high thermal expansion. Preferably, the tricalcium phosphate has a thermal expansion of more than 1%, more preferably more than 1.5%, such as more than 2% when heated from 20° C. to 750° C.

The amount of plaster present in the investment powder affects the expansion properties. Generally about 10% to 30%, by weight plaster is desirable for a tricalcium phosphate/plaster based investment powder. Preferably the plaster is an aridised beta plaster. Plaster is produced by calcination of gypsum (CaSO₄.2H₂O) to form a hemi-hydrate. The process of producing aridised gypsum plaster by calcining gypsum in the presence of an aridising agent, a deliquescent agent, preferably an inorganic deliquescent and particularly calcium chloride, is described in, for example, U.S. Pat. Nos. 1,370,581 and 3,898,316. The resultant product, referred to as aridised plaster, is a plaster with reduced water demand. Aridised plaster is preferably present at about 10% to 30% by weight, preferably 12% to 22%, more preferably 13% to 15% such as 14%.

In addition to tricalcium phosphate the investment powder may contain magnesium oxide. Any suitable form of magnesium oxide may be used. Preferably the magnesium oxide is in the form of dead burned magnesite, also known as DBM. DBM may be formed by sintering magnesite (MgCO₃) at a controlled high temperature. Magnesium oxide also exhibits an expansion profile under heating. While magnesium oxide does not provide as high a level of expansion over the required temperature range as tricalcium phosphate, the tricalcium phosphate can be fibrous and the presence of magnesium oxide as refractory components to provide thermal expansion can improve the ability of the investment powder to flow compared with an investment while still attaining adequate expansion. If used magnesium oxide is preferably present at about 10% to 65%, preferably about 15% to about 50%, more preferably 22% to 45%, more preferably 23% to 28%. Preferably the magnesium oxide used is DBO. Preferably the DBO has a low levels of any silica contaminants such as e.g. less than 10 wt %, more preferably less than 5 wt %, e.g. less than 2 wt % preferably less than 1 wt %. Preferably the magnesium oxide has a mesh size of from about 50 to about 400 e.g. from about 60 to about 325.

Vermiculites, chlorites, micas and talcs have low levels of silica (<1.5 wt %). They may be used in low levels to improve the expansion properties of a tricalcium phosphate/plaster based investment powder. Preferably such minerals are present at less than 25% more preferably 5% to 20% and most preferably 8% to 15% such as about 12% by weight of the investment powder. Preferred minerals include Vermiculite, Nepthaline Cyanite, Kyanite, Chlorites, Feldspar, Mica and Talc. Micas are particularly preferred for this purpose.

Although satisfactory mouldings for some purposes may be achieved with an investment powder consisting solely of plaster and tricalcium phosphate, optionally with magnesite and mica, the properties of the investment powder can be modified as required by the use of additional additive components.

Additives used may include accelerators, retarders, wetting agents, defoamers and suspension agents. In these cases chemicals used in the manufacture of conventional silica based investment powders are effective as the binder used is still plaster. Accelerators and retarders are necessary to control the set time of the investment powder and wetting agents, defoamers, and suspension agents are used to improve the overall surface finish of the casting. The quantity of additives are typically less than 1% by weight of the total investment powder.

In preferred embodiments the additives present comprise by weight:
Setting accelerator—0% to 3%, preferably 0.05% to 0.5%;
Plasticiser to aid fluidity of the slurry when the powder is mixed with water—0% to 3%, preferably 0.02% to 1%;
Setting retarder—0% to 3%, preferably 0% to 1.5%
Defoamer—0% to 0.5%, preferably 0.05% to 0.3%

The investment powder is preferably of fine particle size in order to yield a good surface finish of the cast. The particle sized of the investment powder may be chosen to yield the desired surface properties of the cast item. Preferably therefore the investment powder has a particle size up to about 2000 μm more preferably to from about 100 nm to about 1000 μm e.g. from about 1 μm to about 500 μm such as from about 10 μm to about 100 μm.

A preferred investment powder of the invention thus comprises:
from about 25% to about 75% by weight tricalcium phosphate;
from about 10% to about 30% by weight plaster; and
from about 10% to about 65% by weight magnesium oxide;
the sum of the tricalcium phosphate, plaster and magnesium oxide not exceeding 100 wt %.

A further preferred investment powder of the invention thus comprises:
more than about 30% to about 70% by weight tricalcium phosphate;
from about 10% to about 30% by weight plaster; and
from about 10% to about 60% by weight magnesium oxide;
the sum of the tricalcium phosphate, plaster and magnesium oxide not exceeding 100 wt %.

A still further preferred investment powder of the invention comprises:
10 to 30% plaster
more than 30 to 70% tricalcium phosphate
10 to 60% magnesium oxide
0 to 25% of one or more low silica minerals
0 to 10% additives.

Such investment powders have been tested by the inventors in the production of cast materials and typically yield casts with good surface finish, excellent casting quality and good clean off/quench properties.

A more preferred investment powder of the invention comprises:
from about 35% to about 65% by weight tricalcium phosphate; the tricalcium phosphate preferably having a thermal expansion of more than 1% when heated from 20° C. to 750° C.;
from about 12% to about 22% by weight aridised plaster; and
from about 15% to about 50% by weight magnesium oxide, preferably dead burned magnesite;
and optionally containing between 1% and 25% by weight of a mineral selected from vermiculites, chlorites, micas and talcs;

the sum of the tricalcium phosphate, plaster, magnesium oxide and (if present) mineral selected from vermiculites, chlorites, micas and talcs not exceeding 100 wt %.

Such investment powders have been tested by the inventors in the production of cast materials and typically yield casts with very good surface finish, excellent casting quality and very good clean off/quench properties.

A still more preferred investment powder of the invention comprises:
from about 38% to about 53% by weight tricalcium phosphate; the tricalcium phosphate preferably having a thermal expansion of more than 1.5% when heated from 20° C. to 750° C.;
from about 13% to about 15% by weight aridised plaster, preferably aridised beta plaster;
from about 22% to about 45% by weight magnesium oxide, preferably dead burned magnesite, preferably having a mesh size of from about 50 to about 400; and
between 5% and 20% by weight of a mineral selected from vermiculites, chlorites, micas and talcs, preferably micas;

the sum of the tricalcium phosphate, plaster, magnesium oxide and mineral selected from vermiculites, chlorites, micas and talcs not exceeding 100 wt %.

Such investment powders have been tested by the inventors in the production of cast materials and typically yield casts with excellent surface finish, excellent casting quality and excellent clean off/quench properties.

Any of the preferred investment powders described herein may further comprise one or more accelerators, retarders, wetting agents, defoamers and/or suspension agents as described above; the sum total of the components in the investment powder not exceeding 100 wt %.

Typically the stainless steel flask used in the block mould casting process with conventional gypsum-quartz-cristobalite investment powders is formed from 304 or 316 stainless steel. The reference to 304 or 316 stainless steel is a reference to the commonly used American Iron and Steel Institute AISI nomenclature. 300 series stainless steels are austenitic stainless steels which are chromium-nickel alloys, they are the most widely used stainless steels, in particular the most common austenitic stainless steel, 304 stainless steel, also known as 18/8 based on its composition of 18% chromium and 8% nickel and the second most common austenitic stainless steel, 316 stainless steel, which includes 2% molybdenum.

For use with investment powder and the process of the present invention it is preferred to form the stainless steel flask from a 400 series martensitic stainless steel such as 410 stainless steel. As previously discussed the metal flask will expand when heated in the surface and the expansion of the investment powder must at least match the expansion of the metal flask despite the shrinkage in the gypsum component as it becomes anhydrous in order to maintain the compressive strength of the mould.

304, 316 and 410 stainless steels have different coefficients of linear expansion as follows:

304 stainless has a coefficient of 0.0000173

316 stainless has a coefficient of 0.0000160

410 stainless has a coefficient of 0.0000099

For a cylindrical flask which has a nominal diameter of 100 mm which is heated through 750 degrees centigrade the diameter will be:

304 stainless 100.041

316 stainless 100.038

410 stainless 100.023

A lower expansion of the flask will result in increased compressive strength of the mould for a given investment powder.

On the other hand 304, 316 and 410 stainless steels have different heat resistance characteristics, heat resistance being concerned with decomposition and liberation of carbon (corrosion and oxidation) which can lead to distortion and cross contamination. General accepted maximum continuous service temperatures are:

304 stainless steel 925° C.;

316 stainless steel 925° C.;

410 stainless steel 705° C.

In terms of heat resistance properties of the stainless steels and the requirement to burn out the moulds at elevated temperature, conventionally at around 750° C. it may appear that 410 stainless steel would be less suitable than 304 or 316 stainless steel. However, thermal cycling of steels in the 300 series (such as 304 and 316) causes a high temperature scale to form. The scale has a different coefficient of expansion to that of the base metal which leads to accelerated cracking and distortion. This high temperature scale with accompanying accelerated cracking and distortion is not observed with 400 series martensitic steel such as 410. Thus, although it may seem illogical that maximum generally accepted intermittent service temperatures for 300 series are lower than those for continuous service, that is the case. Generally accepted intermittent service temperatures are:

304 stainless steel 870° C.;

316 stainless steel 870° C.;

410 stainless steel 815° C.

Therefore 410 stainless steel despite having lower oxidation heat resistance characteristics than 304 or 316 stainless steel is capable of performing within the thermal cycling which requires intermittent temperatures during the burn out phase of around 750° C.

With a conventional gypsum-quartz-cristobalite investment powder the phase transformation from alpha to beta form with accompanying positive changes in volume of cristobalite at about 250° C. and quartz at 570° C. provides for sufficient expansion of the investment powder to compensate for shrinkage of the gypsum component and thermal expansion of a conventional 304 or 316 stainless steel flask. For investment powders of the present invention the thermal expansion of the investment powder may approach that of a conventional investment powder but the use of a 410 stainless steel flask can improve the compressive strength of the mould due to lower expansion of the flask and so improve the quality of the mould compared to the use of a 304 or 316 stainless steel flask.

The size of the flask of the invention is not particularly limited, and any conventional flask size can be used. In some embodiments the flask is an 8 inch by 4 inch flask or a 6 inch by 4 inch flask.

### EXAMPLE 1

The following tests were carried out using an investment powder comprising tricalcium phosphate, aridised beta plaster, and dead burned magnesite in flasks of either 316 or 410 stainless steel.

9.8 kg of powder were weighed out and 3.724 litres of water were measured out. This is a mix ratio of 38/100.

4 flasks were prepared, two were 9 by 4 inch 316 flasks and two were 7 by 4 inch 410 flasks.

The powder was added to the water and mixed without vacuum for 30 seconds, the blades were then scraped down and the slurry was mixed under vacuum for 4 minutes. The four flasks were poured in a total of 2.25 minutes and then vacuumed for a further minute.

After release of the vacuum gloss off occurred at a total of 14.75 minutes with a slurry temperature of 18 C.

Burn Out Cycle

The flasks were allowed to bench set for 90 minutes then fired in a furnace using the following burn out cycle—

Heat at 150 C and hour to 220 C

Hold at 220 C for 4 hours

Heat at 150 C an hour to 720 C

Hold at 720 C for 5 hours

Cool to casting temperature

Casting

All castings were done in silver and quenched at 15 minutes

Test 1—316 Flask—9 by 4 inch

Flask temperature 700 C

Metal temperature 1000 C

Metal weight 11 oz

A small amount of flashing was observed in the centre of the tree mainly to one side. 4 pieces were affected.

Test 2—410 Flask—7 by 4 inch

Flask temperature 650 C

Metal temperature 975 C

Metal weight 9.5 oz

On this casting there were no faults.

Test 3—316 Flask—9 by 4 inch

Flask temperature 500 C

Metal temperature 1000 C

Metal weight 17.5 oz

On this 316 flask tree there was again flashing present in the centre of the tree

Test 4—410 Flask—7 by 4 inch

Flask temperature 500 C

Metal temperature 950 C

Metal weight 9.5 oz

This casting appeared perfect with a good surface and quench in the 410 flask.

1. A gypsum bonded investment powder comprising tricalcium phosphate, and containing less than 1% by weight free silica in the respiratory fraction.

2. The investment powder of claim 1 further comprising plaster.

3. An investment powder of claim 2 which comprises more than 30% to 70% by weight tricalcium phosphate.

4. The investment powder of claim 2 wherein the plaster comprises aridised plaster.

5. The investment powder of claim 1 comprising magnesium oxide and/or one or more low silica minerals.

6. (canceled)

7. The investment powder of claim 1 comprising:
10 to 30% plaster
25 to 75% tricalcium phosphate
10 to 65% magnesium oxide
0 to 25% of one or more low silica minerals
0 to 10% additives

8. The investment powder of claim 7 wherein said low silica minerals are selected from the group consisting of Vermiculite, Nepthaline Cyanite, Kyanite, Chlorites, Feldspar, Mica and Talc.

9. The investment powder of claim 1 comprising as an additive one or more wetting agents, de-foam agents, suspension agents, accelerators or retarders.

10. The investment powder of claim 1 having an overall expansion at 750° C. when formed into an investment casting mould of greater than 0.7%, preferably greater than 1% and more preferably greater than 2%.

11. (canceled)

12. A method of making an investment casting slurry by mixing the investment powder of claim 1 with water.

13. A method of making a casting comprising forming a slurry according to the method of claim 12, pouring the slurry around a low melting point material model, allowing the slurry to set to define a mould, heating the mould to burn out the model and casting material into the mould.

14. Use of a composition as an investment powder, said composition comprising
10 to 30% plaster
25 to 75% tricalcium phosphate
10 to 65% magnesium oxide
0 to 25% of one or more low silica minerals
0 to 10% additives

15. A method of making a casting comprising forming a slurry by mixing a gypsum bonded investment powder with water, pouring the slurry into a stainless steel flask around a low melting point material model, allowing the slurry to set to define a mould, heating the mould to burn out the model and casting material into the mould wherein the stainless steel flask consists of a 400 series martensitic stainless steel.

16. The method of claim 15 wherein said 400 series martensitic stainless steel is 410 stainless steel.

17. The method of claim 15 wherein said investment powder comprises an investment powder comprising plaster and calcium phosphate.

18. The method of claim 17 wherein said investment powder comprises tricalcium phosphate and/or magnesium oxide.

19. (canceled)

20. The method of claim 17 wherein said investment powder further comprises one or more low silica minerals.

21. The method of claim 15 wherein said investment powder comprises aridised plaster.

22. The method of claim 15 wherein said investment powder comprises:
10 to 30% plaster
25 to 75% calcium phosphate
10 to 65% magnesium oxide
0 to 25% of one or more low silica minerals
0 to 10% additives

23. The method of claim 15 wherein said investment powder comprises as an additive one or more wetting agents, de-foam agents, suspension agents, accelerators or retarders.

24. (canceled)
